(19) United States
(12) Patent Application Publication
(10) Pub. No.: US 2024/0106844 A1
(43) Pub. Date: Mar. 28, 2024

(54) SYSTEM AND METHOD FOR CYBERSECURITY THREAT DETECTION AND EARLY WARNING

(71) Applicant: INSTITUTE FOR INFORMATION INDUSTRY, TAIPEI CITY (TW)

(72) Inventors: Chih-Kai CHEN, TAIPEI CITY (TW); Po-Yu LIAO, TAIPEI CITY (TW)

(73) Assignee: INSTITUTE FOR INFORMATION INDUSTRY, TAIPEI CITY (TW)

(21) Appl. No.: 17/979,429

(22) Filed: Nov. 2, 2022

(30) Foreign Application Priority Data
Sep. 27, 2022 (TW) 111136620

(51) Int. Cl. H04L 9/40; H04L 41/142

(52) U.S. Cl. CPC H04L 63/1425; H04L 41/142; H04L 63/1416

(57) ABSTRACT

A system and a method for cybersecurity threat detection and early warning are provided. The method includes the following steps: determining whether a network element has an abnormal change according to operation information; if yes, performing a deduction by a cybersecurity event inference model according to the operation information of an abnormal network element to generate a cybersecurity prediction warning; at the same time, collecting and comparing cybersecurity event information and further performing a self-response test on the abnormal network element and a comparison for response result information to finally generate a threat event decision. The cybersecurity prediction warning provides early warning of potential cyberattacks, and the threat event decision provides a robust judgment of the cyberattack event. The present invention solves the problems of long determination time and easily missing judgment and misjudgment.

### CROSS-REFERENCE TO RELATED APPLICATIONS

This application claims the priority benefit of TW application serial No. 111136620, filed on Sep. 27, 2022. The entirety of the above-mentioned patent application is hereby incorporated by reference herein and made a part of specification.

### BACKGROUND OF THE INVENTION

### 1. Field of the Invention

The present invention relates to a system and method for threat detection and early warning, and more particularly to system and method for cybersecurity threat detection and early warning.

### 2. Description of the Related Art

The 5^{th} Generation (5G) mobile network system adopts open system architecture. Namely, any network element that complies with the 5G standard and interface specification may legally connect to the system, communicate with the other network elements, and utilize the system function. The network administrator uses a network management system as the control center of the 5G system, and receives the performance information and abnormal warning information of the network elements and network element connection interfaces in the network system. The performance information and abnormal warning information are originally recorded information of each network element according to the real time condition; when there are a large amount of network elements in the system, forming a complex network, the amounts of the performance information and the abnormal warning information are also enormously large. Furthermore, abnormal change in the performance information or increasing of the abnormal warning information are not necessarily caused by cybersecurity threat such as hacker attack or illegal internet robots. It is also possible that an abnormal change is caused by unusual but legal usages such as massive crowd gathered for a public event that leads to a surge of internet traffic, or a launch for sale of concert tickets that leads to tens of thousands of connection requests in a short period of time. Therefore, how to analyze the original information and distinguish the differences between the abnormal changes caused by different causes, and detect or even predict the happening of cyber security threat events is a difficult subject to be solved.

Mirroring full-flow analysis is a commonly implemented technique for cybersecurity threat detection strategy of a 5G network system. The technique includes steps of collecting all of the original data flow information in the 5G network system, saving them in a database, establishing indexes, and performing Real-time analysis and Backtracking analysis by big data analysis, machine learning and deep learning. However, full-flow analysis has the characteristic of diverse protocols, highly simultaneous browser connections, and complex parameter structures, leading to great amount of data to be analyzed. As a result, cybersecurity threat events are easily missing from judgement or misjudged. Determination time may be delayed even when correctly detected, such that it is too late to prevent or interrupt the attack. Therefore, the cybersecurity threat detection technique needs to be improved.

### SUMMARY OF THE INVENTION

An objective of the present invention is to provide a system and method for cybersecurity threat detection and early warning.

To achieve the foregoing objective, the system for cybersecurity threat detection and early warning includes multiple network elements, multiple network element connection interfaces and a network system, operates in an operation, administration, and management (OAM) layer, and includes a storage and a processor.

The storage stores operation information and test records of each network element, and a cybersecurity event inference model. The processor is electrically connected to the storage and configured to perform the following steps: determining whether any one of the network elements has an abnormal change according to the operation information of each network element; if any one of the network elements has the abnormal change, generating an abnormal change warning, and defining the network element that has the abnormal change as an abnormal network element; performing a deduction with the cybersecurity event inference model according to the abnormal change warning and the operation information of the abnormal network element to generate a threat event prediction probability value, and generating a cybersecurity prediction warning when the threat event prediction probability value is higher than a prediction threshold; collecting a cybersecurity event information according to the abnormal network element, and comparing the cybersecurity event information with the operation information of the abnormal network element to generate a threat risk value; and when the threat risk value is higher than a threat risk threshold, controlling the abnormal network element to perform a self-response test to generate a response result information, and comparing the response result information with the test record to generate a threat event decision.

A method for cybersecurity threat detection and early warning is also provided in the present invention. The method is implemented in the OAM layer, performed by a processor, and includes the following steps: determining whether any one of the network elements has an abnormal change according to the operation information of each network element; when any one of the network elements has the abnormal change, generating an abnormal change warning, and defining the network element that has the abnormal change as an abnormal network element; performing a deduction with the cybersecurity event inference model according to the abnormal change warning and the operation information of the abnormal network element to generate a threat event prediction probability value, and generating a cybersecurity prediction warning when the threat event prediction probability value is higher than a prediction threshold; collecting a cybersecurity event information according to the abnormal network element, and comparing the cybersecurity event information with the operation information of the abnormal network element to generate a threat risk value; and if the threat risk value is higher than a threat risk threshold, controlling the abnormal network element to perform a self-response test to generate a response result information, and comparing the response result information with the test record to generate a threat event decision.

The method for cybersecurity threat detection and early warning of the present invention is performed by the system for cybersecurity threat detection and early warning. At first, the processor determines if any one of the network elements has an abnormal change according to the operation information, and if yes, the processor collects cybersecurity event information of the abnormal network element for further judgement. The evaluation of cybersecurity event includes a prompt and early prediction and a precise decision. For the prediction part, the prebuilt cybersecurity event inference model is utilized to generate the threat event prediction probability value and the cybersecurity prediction warning accordingly; for the threat event decision part, the collected cybersecurity event information is compared with the operation information to generate the threat risk value, and if the threat risk value is above the threshold, the processor further controls the abnormal network element to perform self-response test to generate the threat event decision according to the response result.

The system and method for cybersecurity threat detection and early warning of the present invention utilize the cybersecurity event inference model to provide a prompt early warning mechanism for threat event when a network element has abnormal change, so that the network administrator can notice the abnormal network element at an early stage, increasing the preparation time for protection to stop the threat event. The threat event decision is made with comparison of cybersecurity event information for threat risk value and further verifying the risk by self-response test, providing a precise judgement of the event, lowering the chance of misjudgment.

In conclusion, the present invention provides a timely early warning mechanism and robust event decision outcome at the same time, overcoming the disadvantage of easily missing judgment and misjudgment of conventional cybersecurity event detection technique with big data mirroring full-flow analysis.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of a 5G network system.

FIG. 2 is a block diagram of a system for cybersecurity threat detection and early warning of the present invention.

FIG. 3 is a flow chart of a method for cybersecurity threat detection and early warning of the present invention.

FIG. 4 is a curve diagram of the operation information of a method for cybersecurity threat detection and early warning of the present invention.

FIG. 5 is a curve diagram of the operation information and cybersecurity event information of a method for cybersecurity threat detection and early warning of the present invention.

FIG. 6 is a flow chart of an embodiment of a method for cybersecurity threat detection and early warning of the present invention.

FIG. 7 is a flow chart of another embodiment of a method for cybersecurity threat detection and early warning of the present invention.

FIG. 8 is a diagram of the 5G network system with abnormal relation weighting given to the relating operation information in a method for cybersecurity threat detection and early warning of the present invention.

### DETAILED DESCRIPTION OF THE INVENTION

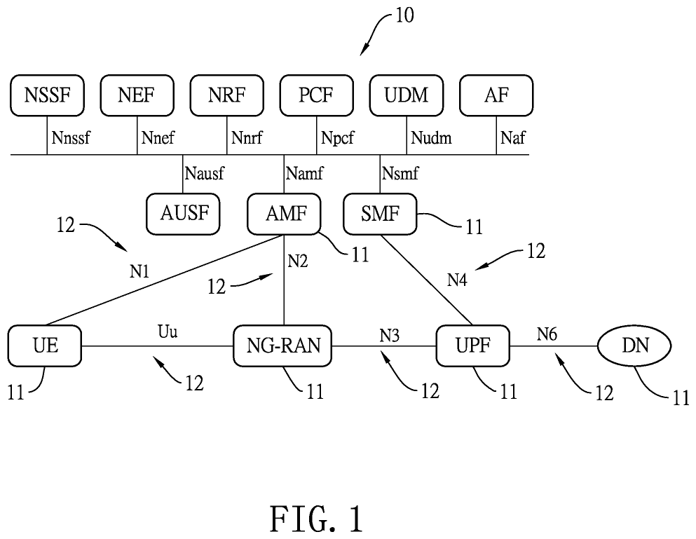

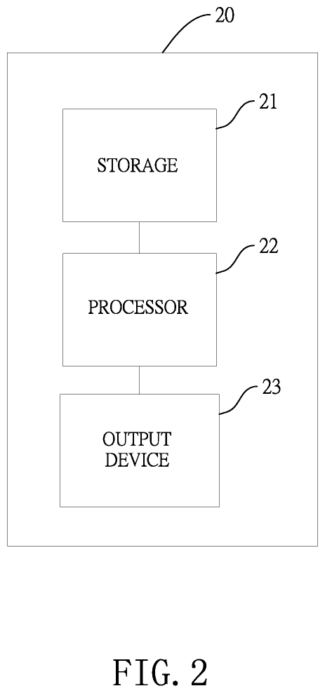

With reference to FIG. 1 and FIG. 2, the present invention is a system for cybersecurity threat detection and early warning 20 including multiple network elements 11, multiple network element connection interfaces 12 and a network system 10. The system for cybersecurity threat detection and early warning 20 is implemented in an Operations, Administration, and Maintenance (OAM) layer. For instance, the network system 10 is a 5^{th} generation mobile communication network system including multiple network elements 11. The multiple network elements 11 may include AMF (Access And Mobility Management Function), SMF (Session Management Function), UE (User Equipment), NG-RAN (New Generation Radio Access Network), UPF (User Plane Function) DN (Data Network), etc., and the network element connection interfaces 12 include Uu interface connecting the NG-RAN and UE, N1 interface connecting the UE and AMF, N2 interface connecting NG-RAN and AMF, N3 interface connecting NG-RAN and UPF, N4 interface connecting UPF and SMF, N6 interface connecting UPF and DN, and so on. Other elements and interfaces are presented in detail in FIG. 1 and are herein omitted.

With reference to FIGS. 1, 2 and 3, the system 20 for cybersecurity threat detection and early warning includes a storage 21 and a processor 22, the storage 21 stores operation information, test records, and a cybersecurity event inference model. The operation information may include performance information of the elements 11, such as at least one of or a combination of the following: a remaining storage, a processing speed, and performance of the network elements, an interface traffic of the network element connection interfaces 12, a connection quantity, and a registering quantity of the network element connection interfaces 12. The processor 22 is electrically connected to the storage 21 to access the information stored in the storage 21, and perform the method for cybersecurity threat detection and early warning according to the change in the operation information. The method includes steps S101-S106.

In step S101, the processor 22 reads the operation information and the test records of each of the network elements 11 from the storage 21.

In step S102, the processor 22 determines whether any one of the network elements 11 has an abnormal change according to the operation information of each network element 11. To be more specific, in an embodiment, the processor 22 calculates an interval growth rate of the operation information from a network element 11 according to a preset cycle, and determines whether the interval growth rate meets an abnormal threshold condition; if yes, determines the network element 11 has an abnormal change. The abnormal threshold condition may be set to at least one interval growth rate in one preset cycle higher than a corresponding abnormal threshold, or be set to the interval growth rates in multiple preset cycles higher than the corresponding abnormal threshold. Detail is further elaborated below.

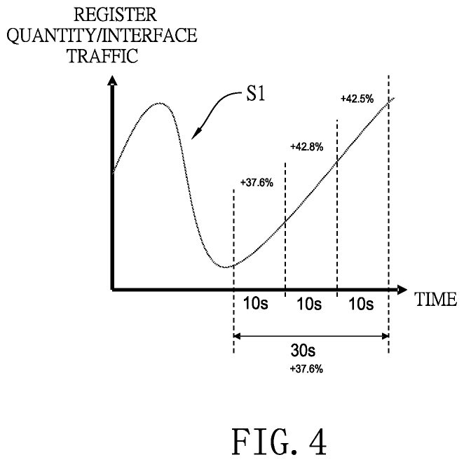

With reference to FIG. 4, a register quantity/interface traffic curve S1 over time of the N1 interface is shown as an example for the network element connection interfaces 12. In an embodiment, the processor 22 may utilize a traffic analysis software to perform the traffic analysis. The preset cycle may be set for 10 seconds or 30 seconds. The processor 22 calculates the interval growth rate of the register quantity/interface traffic in every 10 seconds or every 30 seconds, and sets different abnormal thresholds for interval growth rates of different preset cycles. For instances, when the preset cycle is 10 seconds, the abnormal threshold is set in 35%; when the preset cycle is 30 seconds, the abnormal threshold is set in 33%. When a period growth rate in any one of the preset cycles is higher than the corresponding abnormal threshold, or preset growth rates in two or more preset cycles are higher than the corresponding abnormal thresholds, then the abnormal threshold condition is met. In the register quantity/interface traffic curve S1 over time in FIG. 4, growth rates in three 10-second preset cycles are 37.6%, 42.8%, 42.5%, all of which are higher than the 35% abnormal threshold, and a growth rate in a 30-second preset cycle is 33%, which is also higher than the 30-second abnormal threshold. Therefore, the abnormal threshold condition is met.

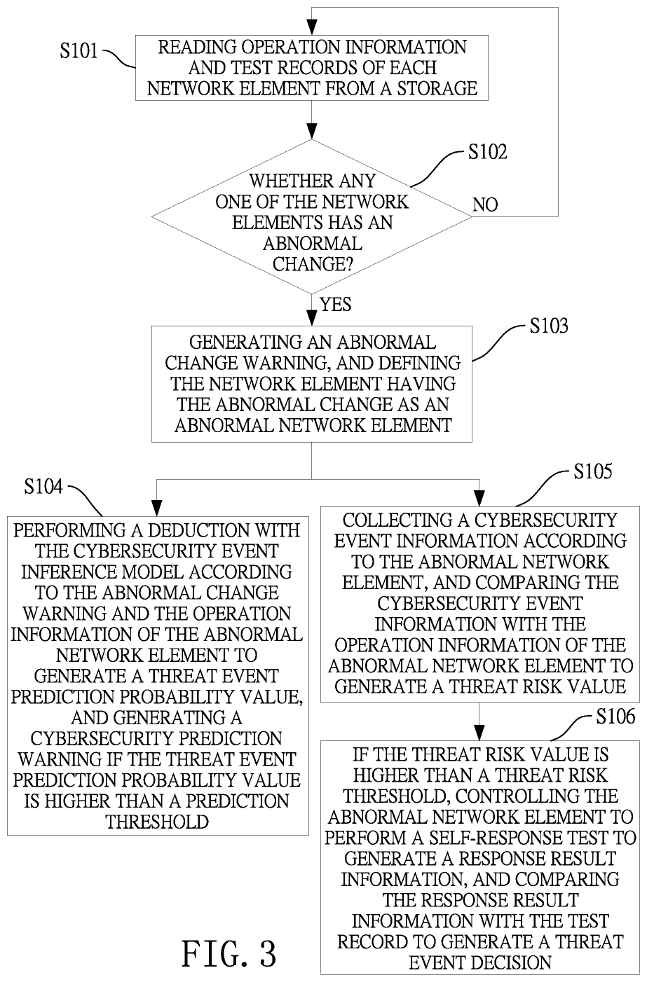

With reference to FIG. 3, in step S102, when any one of the network elements 11 meets the abnormal threshold condition, then into step S103, the processor 22 generates the abnormal change warning and determines the network element 11 that has the abnormal change is the abnormal network element. The abnormal change warning triggers the stage 1 process for cybersecurity prediction warning (step S104) and the stage 2 process for threat event decision (step S105-S106).

Again with reference to FIG. 3, in step S104, when the processor 22 determines the presence of the abnormal network element, the processor 22 performs an inference with the cybersecurity event inference model according to the abnormal change warning and the operation information of the abnormal network element to generate a threat event prediction probability value. The processor 22 further generates a cybersecurity prediction warning if the threat event prediction probability value is higher than a prediction threshold. In the present embodiment, the cybersecurity event inference model may be a convolutional neural network (CNN). The cybersecurity event inference model is trained with the operation information, historical abnormal conditions, corresponding cybersecurity events, and the threat events causing the abnormal conditions under supervised learning. When the cybersecurity event inference model performs the deduction with the operation information of the abnormal network information, the more the network information is in line with a specific trend, the higher the threat event prediction probability value that is generated.

Again with reference to FIG. 2, preferably, the system 20 includes an output device 23, which may be a display screen or an audio speaker device. When the processor 22 generates the cybersecurity prediction warning, the processor 22 controls the output device 23 to play a cybersecurity prediction warning message, which may be a warning image or a warning sound to notify the network administrator to do a preliminary check or action.

Again with reference to FIG. 3, in step S105, when the processor 22 generates the abnormal change warning and the determination of the abnormal network element, the processor 22 further collects the cybersecurity event information according to the abnormal network element. The cybersecurity event information is the error messages of the network elements 11 in the network system 10, including at least one of or a combination of safety audit and daily log of the network elements, abnormal communication data packet information of the network element connection interfaces, and abnormal signaling information between the network elements 11. The processor 22 then compares the cybersecurity event information with the operation information of the abnormal network element to determine if there is a corresponding trend between the cybersecurity event information and the operation information to generate a preliminary threat risk value. To be more specific, the threat risk value is generated according to a comparison between the cybersecurity event information and the operation information of the abnormal network information aligned to each other by a time division.

A network attacker often executes experimental call to the API ports of a targeted network element 11 before the actual attack, and then makes the attack afterward according to the result. The request method and the URL of such experimental call is different to that of a normal service request to the network element 11, and therefore the experimental call of the attacker will cause abnormal changes in the operation information and the cybersecurity event information of the network element. To be more specific, a time difference may appear between the change in the operation information and the change in the cybersecurity event information caused by either the experimental call or the actual attack.

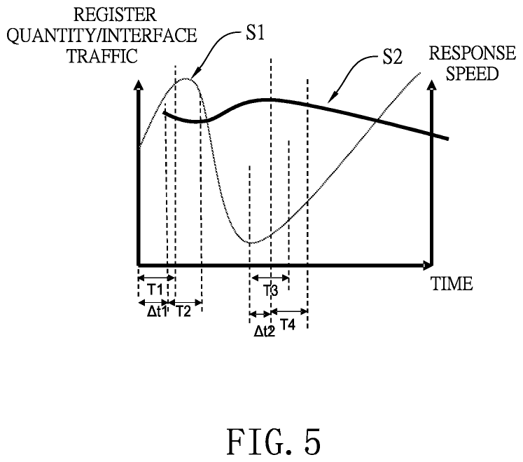

With reference to FIG. 5, the comparison process of the operation information and cybersecurity event information considering the two conditions mentioned above will be further explained with the example in FIG. 5. As a continuous example to FIG. 4, the register quantity/interface traffic curve S1 over time and a response speed curve S2 over time are presented simultaneously in FIG. 5. As the network attacker executes the experimental call, in time period T1, the register quantity/interface traffic rises dramatically, according to S1, but the response speed of the network element 11 drops correspondingly in time period T2, according to S2. Furthermore, as the network attacker starts the actual attack, the register quantity/interface traffic rises dramatically again in time period T3, according to S1, but the response speed of the network element 11 drops correspondingly in time period T4, according to S2. As shown in FIG. 5, a delaying time difference Δt1 is between time period T2 and time period T1, and a delaying time difference Δt2 is between time period T4 and time period T3. The start point of time period T1 is determined when a slope of the register quantity/interface traffic is higher than a first threshold, and the start point of time period T2 is determined when a slope of the response time is higher than a second threshold. The time difference Δt1 is the difference between the start points of time periods T1 and T2. The time difference Δt2 is determined similarly and the process is hereby omitted. The processor 22 aligns the register quantity/interface traffic and the operation information according to the time differences before the actual comparison process. For example, the processor 22 shifts the register quantity/interface traffic in time period T1 by Δt1, and compares the shift register quantity/interface traffic with the response time in T2. When the operation information and the cybersecurity event information are aligned and compared, the more similar the tendency of the two information, the higher the threat risk value.

Again with reference to FIG. 3, in step S106, when the threat risk value is higher than a threat risk threshold, the processor 22 further controls the abnormal network element to perform a self-response test to generate a response result information, and further compares the response result information with the test records stored in the storage 21 to generate a threat event decision. In some embodiments, the self-response test includes at least one of or a combination of the following operations: interrupting at least one of the network element connection interfaces 12 corresponding to the abnormal network element, limiting the traffic of the at least one of the network element connection interfaces 12 corresponding to the abnormal interface, increasing the response delay of the abnormal network element, and restarting the abnormal network element. The processor 22 then records the test response information of the abnormal network element after the operation(s).

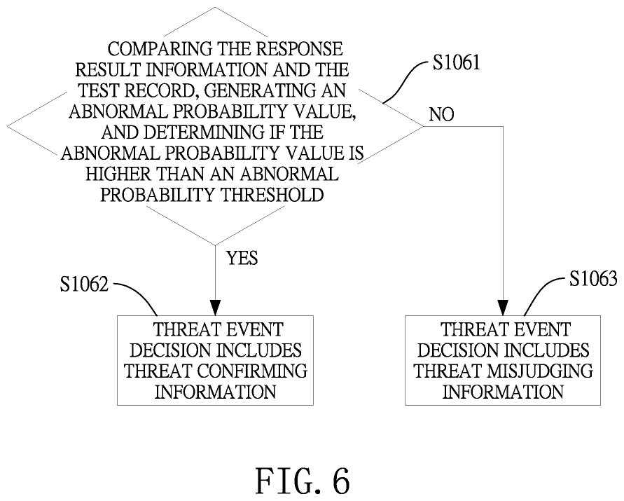

With reference to FIG. 6, to be more specific, step S106 includes the following sub-steps:
In step S1061, when the processor 22 compares the response result information and the test records, the processor 22 first generates an abnormal probability value, and determines if the abnormal probability value is higher than an abnormal probability threshold.
In step S1062, if the abnormal probability value is higher than the abnormal probability threshold, the threat event decision includes the threat confirming information;
In step S1063, if the abnormal probability value is lower than the abnormal probability threshold, the threat event decision includes a threat misjudging information.

The test records stored in the storage 21 include historical self-response test, corresponding historical response result information, and corresponding historical threat probability value. When a test response information meets one of the historical response result information in the test records, and the historical response result information corresponds to a high historical threat probability value, it means that a cybersecurity threat event is likely to happen, therefore the processor 22 gives a high abnormal probability value. When a test response information meets another historical response result information in the test records, and another historical response result information corresponds to a low historical threat probability value, it means that a cybersecurity threat event is unlikely to happen, therefore the processor 22 gives a low abnormal probability value.

As an example, for the NG-RAN network element 11 in FIG. 1, when the number of requested connections from a UE increased abruptly (an abnormal change happens), it may be caused by an ongoing DDoS attack, but it also may be caused by a legitimate and reasonable event such as public rush for online ticket sale. In one of the self-response tests, the processor 22 controls the NG-RAN network element 11 to interrupt the Uu interface between the NG-RAN network element 11 and the UE that request for a large number of connections, and records the change in the connection number of the NG-RAN network element 11 as the response result information.

In a first situation, after interrupting the Uu interface, the response result information shows that the decrease in the connection number is relatively low, perhaps under two digit, meaning the abnormal change in the NG-RAN is more likely to be caused by legitimate usage rather than a network attack. Under this situation, when the processor 22 compares the response result information with the test records stored in the storage 21, the abnormal probability value generated by the processor 22 will be lower than the abnormal probability threshold, and therefore the threat event decision includes a threat misjudging information.

In a second situation, after interrupting the Uu interface, the response result information shows that the decrease in the connection number is relatively high, perhaps above hundreds or thousands, meaning the abrupt surge in connection number is likely to be caused by DDoS attack using bot machines. Under this situation, when the processor 22 compares the response result information with the test records stored in the storage 21, the abnormal probability value generated by the processor 22 will be higher than the abnormal probability threshold, and therefore the threat event decision includes a threat confirming information. As a result, the self-response test can distinguish the difference between the reasonable and legitimate special usages such as high intensity gathering crowd or rush for a sale launch, and illegal usages such as network attack.

Preferably, the processor 22 controls the output device 23 to output a threat event decision message, notifying the network administrator to review the decision result for further advanced action.

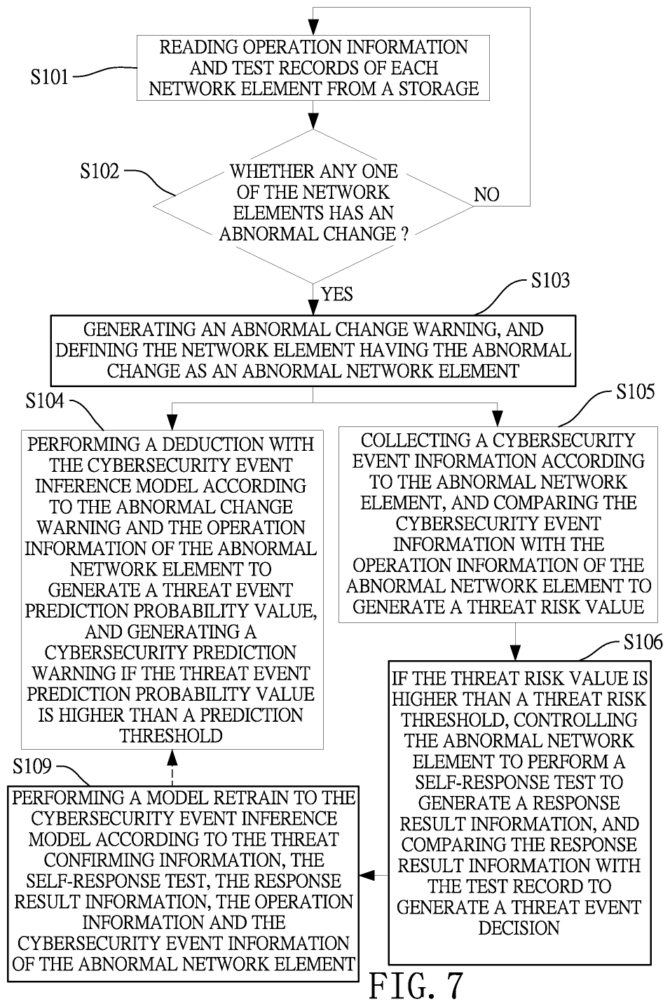

With reference to FIG. 7, in another embodiment, the processor 22 further performs the following steps after generating the threat event decision.

In step S107, the processor 22 collects multiple pieces of relating operation information of the abnormal network element, and determines whether each piece of relating operation information meets a respective corresponding key abnormal condition. The relating operation information includes the operation information of the network element connection interface 12 connected to the abnormal network element, and other network elements 11 connected to the abnormal network element through the network element connection interface 12.

Again with reference to FIG. 7, in step S108, if at least two pieces of relating operation information meet the key abnormal condition, the processor 22 generates a threat event review score and a corresponding threat event review result according to the at least two pieces of relating operation information that meet the key abnormal condition.

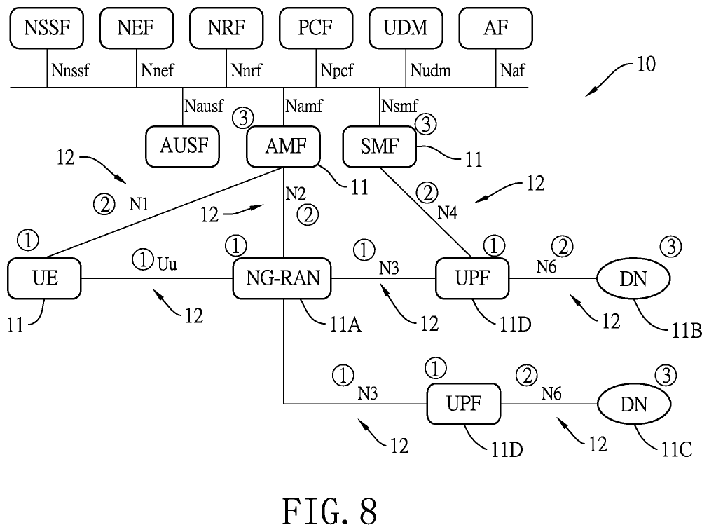

Further with reference to FIG. 8, for example, a connected network element 11B (DN) connected to an abnormal network element 11A (NG-RAN) has a relating operation information of server loading, and the key abnormal condition is the server loading higher than an upper limit A %. When the connected network element 11B receives a large amount of HTTP GET requests, causing the server loading to rise above A %, it means the connected network element 11B is likely to be suffering from a session flood attack. On the other hand, another connected network element 11C (DN) of an abnormal network element 11A (NG-RAN) has a relating operation information of server performance, and the key abnormal condition is the key abnormal condition lower than a lower limit B %. When the connected network element 11C receives a large amount of HTTP POST requests, causing the server loading to drop to below B %, it means the connected network element 11C is likely to be suffering from a post flood attack. Furthermore, if both the relating operation information of the connected network elements 11B and 11C meet the key abnormal condition, it means that a network attack is very likely to happen and the abnormal network element 11A is involved in the attack. Therefore the threat event review score is given according to the two pieces of relating operation information meeting the key abnormal condition. When the threat event review score is higher than a preset score threshold, the processor 22 generates a threat event review result that further confirms the threat event confirming information.

Further with reference to FIG. 8, in yet another embodiment, when the processor 22 generates the threat event review score, the processor 22 gives an abnormal relation weighting to each piece of the relating operation information and calculates the threat event review score according to a data stream relating degree of each piece of the relating operation information corresponding to the abnormal network element.

To be more specific, when the cybersecurity event occurs, other network elements 11 on the data stream of the event will be interfered with. Namely, the cybersecurity event is a chain reaction in the network system 10. For example, when a cybersecurity event is a flood attack by network elements 11 (UE) through the abnormal network element 11A (NG-RAN), necessarily the data will pass through the abnormal network element 11A and network element 11D (UPF). Therefore the abnormal network element 11A and the network element 11D, and the network element connection interfaces 12 such as Uu and N3 interface is given the highest abnormal relation weighting \textcircled{1}. Furthermore, to implement other functions in the network system 10, some data may pass through other network element connection interfaces 12 such as N1, N2, N4, N6, therefore those network element connection interfaces 12 are given the second highest abnormal relation weighting \textcircled{2}. Some less important network elements 11 such as AMF, SMF, and network elements 11B, 11C connected by the network element connection interfaces 12 with abnormal relation weighting \textcircled{2} are given abnormal relation weighting \textcircled{3}, and so on. Symbols \textcircled{1}, \textcircled{2}, \textcircled{3} represent weighting orders from high to low. It shall be explained that, in the example described above, the abnormal relation weighting is set considering the NG-RAN abnormal network element 11A as the center, and considering its corresponding general data stream. If the abnormal network element is at a different position in the network system, such as the abnormal network element being the AMF, then the abnormal relation weighting of other network elements 11 and the network element connection interfaces 12 shall be set differently. The abnormal relation weightings may also be different for each network element 11 if the network system 10 is applied in different situations. As a result, as the processor 22 calculates the threat event review score, the processor 22 considers the abnormal relation weighting to generate a precise threat event review score.

Again with reference to FIG. 7, finally, in step S109, when the threat event decision includes the threat confirming information, or in step S107-S108, the threat event review result further confirms the threat confirming information, the processor 22 performs a model retrain to the cybersecurity event inference model according to the threat confirming information, the self-response test, the response result information, the operation information and the cybersecurity event information of the abnormal network element.

As mentioned in the description of S104, the cybersecurity event inference model is configured to perform deduction according to the operation information of the abnormal network element to generate the threat event prediction probability value. After the processor 22 generates the threat confirming information according to a series of cybersecurity evaluation processes such as the comparison of the cybersecurity event information and the operation information, performing self-response test and generating response result information, the processor 22 retrains the cybersecurity event inference model according to those information to strengthen the model and improve the accuracy of the cybersecurity event inference model.

To sum up, the system and method for cybersecurity threat detection and early warning combine the detection and the early warning of the cybersecurity event. In a first stage, the cybersecurity event inference model is used to generate cybersecurity prediction warning promptly, giving the network administrator a heads-up that a network attack may be happening or is in the early stage of happening; in the second stage, a series of evaluation process of comparison of the cybersecurity event information and the operation information, performing self-response test and generating response result information to generate the threat confirming information, which may be further confirmed with the threat event review score. The robust and reliable threat event decision is provided to the network administrator as a final result. At last, the threat event decision is fed back to the cybersecurity event inference model for retraining, such that the cybersecurity event inference model is strengthened in the operation of the system, and may provide more precise and robust cybersecurity prediction warnings afterward.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A system for cybersecurity threat detection and early warning, including multiple network elements, multiple network element connection interfaces, and a network system, operating in an Operation, Administration, and Management (OAM) layer, and comprising:
a storage, being configured to store operation information and test records of each network element, and a cybersecurity event inference model;
a processor, electrically connected to the storage, and being configured to:
determine whether any one of the network elements has an abnormal change according to the operation information of each network element;
when any one of the network elements has the abnormal change, generate an abnormal change warning, and define the network element that has the abnormal change as an abnormal network element;
perform a deduction with the cybersecurity event inference model according to the abnormal change warning and the operation information of the abnormal network element to generate a threat event prediction probability value, and generate a cybersecurity prediction warning when the threat event prediction probability value is higher than a prediction threshold;
collect cybersecurity event information according to the abnormal network element, and compare the cybersecurity event information with the operation information of the abnormal network element to generate a threat risk value; and
when the threat risk value is higher than a threat risk threshold, control the abnormal network element to perform a self-response test to generate a response result information, and compare the response result information with the test record to generate a threat event decision.

2. The system as claimed in claim 1, wherein the processor is further being configured to:
calculate an interval growth rate of the operation information according to a preset cycle;
determine whether the interval growth rate meets an abnormal threshold condition, and if yes, determine the network element has the abnormal change.

3. The system as claimed in claim 1, wherein the processor is further being configured to:
when the threat event decision is a threat confirming information, perform a model retrain to the cybersecurity event inference model according to the threat confirming information, the self-response test, the response result information, the operation information, and the cybersecurity event information of the abnormal network element.

4. The system as claimed in claim 3, wherein the processor is further being configured to:
compare the response result information and the test record to generate an abnormal probability value;
when the abnormal probability value is higher than an abnormal probability threshold, the threat event decision includes the threat confirming information;
when the abnormal probability value is lower than the abnormal probability threshold, the threat event decision includes a threat misjudging information.

5. The system as claimed in claim 1, wherein the self-response test includes operation selected from the group consisting of:
interrupting at least one of the network element connection interfaces corresponding to the abnormal network element, limiting the traffic of the at least one of the network element connection interfaces corresponding to the abnormal network element, increasing response delay of the abnormal network element, or restarting the abnormal network element; and
recording the response result information of the abnormal network element.

6. The system as claimed in claim 4, wherein the processor is further being configured to:
collect multiple pieces of relating operation information of the abnormal network element, and determining whether each piece of relating operation information meets a respective corresponding key abnormal condition; and
when at least two of the multiple pieces of relating operation information meet the key abnormal condition, generate a threat event review score and a threat event review result according to the at least two of the multiple pieces of relating operation information that meet the key abnormal condition.

7. The system as claimed in claim 6, wherein when the processor generates the threat event review score, the processor gives an abnormal relation weighting to each piece of the relating operation information and calculates the threat event review score according to a data stream relating degree of each piece of the relating operation information corresponding to the abnormal network element.

8. The system as claimed in claim 1, wherein the operation information is selected from the group consisting of:
a remaining storage, a processing speed, and a performance of the network elements, information traffic, a connection quantity, and a registering quantity of the network element connection interfaces.

9. The system as claimed in claim 1, wherein the cybersecurity event information is selected from the group consisting of:
a safety audit and daily log of the network elements, an abnormal communication data packet information of the network element connection interfaces, and an abnormal signaling information between the network elements.

10. The system as claimed in claim 1, wherein the threat risk value is generated according to a comparison between the cybersecurity event information and the operation information of the abnormal network aligned to each other by a time division.

11. A method for cybersecurity threat detection and early warning, operating in an Operation, Administration and Management (OAM) layer, performed by a processor, and comprising the following steps:
reading operation information and test records of each of multiple network elements from a storage;
determining whether any one of the network elements has an abnormal change according to the operation information of each network element;
when any one of the network elements has the abnormal change, generating an abnormal change warning, and defining the network element that has the abnormal change as an abnormal network element;
performing a deduction with a cybersecurity event inference model according to the abnormal change warning and the operation information of the abnormal network element to generate a threat event prediction probability value, and generating a cybersecurity prediction warning when the threat event prediction probability value is higher than a prediction threshold;
collecting cybersecurity event information according to the abnormal network element, and comparing the cybersecurity event information with the operation information of the abnormal network element to generate a threat risk value; and
when the threat risk value is higher than a threat risk threshold, controlling the abnormal network element to perform a self-response test to generate a response result information, and comparing the response result information with the test record to generate a threat event decision.

12. The method as claimed in claim 11, wherein in the step of determining whether any one of the network elements has an abnormal change according to the operation information of each network element further includes the following sub-steps:
calculating an interval growth rate of the operation information according to a preset cycle;
determining whether the interval growth rate meets an abnormal threshold condition, and if yes, determining the network element has the abnormal change.

13. The method as claimed in claim 11, wherein
when the threat event decision is a threat confirming information, perform a model retrain to the cybersecurity event inference model according to the threat confirming information, the self-response test, the response result information, the operation information and the cybersecurity event information of the abnormal network element.

14. The method as claimed in claim 11, further comprising the following steps:
comparing the response result information and the test record to generate an abnormal probability value;
when the abnormal probability value is higher than the abnormal probability threshold, the threat event decision includes the threat confirming information;
when the abnormal probability value is lower than the abnormal probability threshold, the threat event decision includes a threat misjudging information.

15. The method as claimed in claim 11, wherein the self-response test includes operation selected from the group consisting of:
interrupting at least one network element connection interface corresponding to the abnormal network element, limiting the traffic of the at least one network element connection interface corresponding to the abnormal interface, increasing response delay of the abnormal network element, or restarting the abnormal network element; and
recording the response result information of the abnormal network element.

16. The method as claimed in claim 11, further comprising the following steps:
collecting multiple pieces of relating operation information of the abnormal network element, and determining whether each piece of relating operation information meets a respective corresponding key abnormal condition; and
if at least two of the multiple pieces of relating operation information meet the key abnormal condition, generating a threat event review score and a threat event review result according to the at least two of the multiple pieces of relating operation information that meet the key abnormal condition.

17. The method as claimed in claim 16, wherein when generating the threat event review score, the processor gives an abnormal relation weighting to each piece of the relating operation information and the threat event review score is calculated according to a data stream relating degree of each piece of the relating operation information corresponding to the abnormal network element.

18. The method as claimed in claim 11, wherein the operation information is selected from the group consisting of:
a remaining storage, a processing speed, and a performance of the network elements, an information traffic, a connection quantity, and a registering quantity of multiple network element connection interfaces.

19. The method as claimed in claim 11, wherein the cybersecurity event information is selected from the group consisting of:
a safety audit and daily log of the network elements, an abnormal communication data packet information of multiple network element connection interfaces, and an abnormal signaling information between the network elements.

20. The method as claimed in claim 11, wherein the threat risk value is generated according to a comparison between the cybersecurity event information and the operation information of the abnormal network element aligned to each other by a time division.
